(19) United States
(12) Patent Application Publication
(10) Pub. No.: US 2019/0005928 A1
(43) Pub. Date: Jan. 3, 2019

(54) APPARATUS AND METHOD FOR MANUFACTURE OF DRUM SHELL USING REDUCED-PLY SCARFING

(71) Applicant: DRUM WORKSHOP, INC., Oxnard, CA (US)

(72) Inventor: JOHN J. GOOD, THOUSAND OAKS, CA (US)

(21) Appl. No.: 16/023,142

(22) Filed: Jun. 29, 2018

Related U.S. Application Data
(60) Provisional application No. 62/527,757, filed on Jun. 30, 2017.

(51) Int. Cl. G10D 13/02; B27D 1/06; B27D 1/08; B27D 1/10

(52) U.S. Cl. CPC G10D 13/028; B27D 1/10; B27D 1/08; B27D 1/06

(57) ABSTRACT

Disclosed herein are drum shells and methods of forming drum shells with plies that are individually scarfed, or with combinations of plies that are scarfed separately from one or more other plies. In some embodiments, the radial location of the joints of the plies can be varied around the drum shell, resulting in the removal of an inherent weak point in traditionally formed drum shells where all plies have a joint at approximately the same radial position.

This application claims the benefit of U.S. Provisional Pat. App. No. 62/527,757 to Good, filed on Jun. 30, 2017 and entitled “Apparatus and Method for Manufacture of Drum Shell Using Single-Ply Scarfing,” which is fully incorporated by reference herein in its entirety.

### BACKGROUND

### 1. Field of the Disclosure

The present disclosure relates to musical instruments, and specifically to percussion instruments, and even more specifically to musical instruments such as percussion instruments which are manufactured using single- or reduced-ply scarfing methods, as well as the apparatuses used in such methods and the devices produced by such methods and apparatuses.

### 2. Description of the Related Art

While solid wood drum shells exist, many drum shells manufactured today include multiple plies of wood. The use of multiple plies can provide strength and/or decrease warping over solid drum shells. In prior art methods, first plywood is formed of the various plies of wood (e.g., via gluing), and then the plywood is scarfed such that the two plywood ends will fit with one another when the plywood is rolled into the typical cylindrical drum shell shape. For example, FIG. 1A shows a schematic view of one end of a pre-scarfing piece of plywood 100. FIG. 1B shows the post-scarfing piece of plywood 100′, including a scarfed end 102′. When the other end of the piece of plywood 100/100′ (not shown) is similarly scarfed with an accompanying shape, the plywood 100′ can be rolled into a cylindrical shape and made into a drum shell.

### SUMMARY OF THE DISCLOSURE

The present disclosure is related generally to scarfing of multiple plies of wood to form a drum shell, where at least some of the plies of wood are scarfed separately from one another and/or while not attached to one another. The present disclosure also relates to drum shells with scarf joints at differing radial points.

One embodiment of a method of manufacturing a drum shell according to the present disclosure includes separately scarfing first and second plies of wood, combining the first and second plies of wood into a piece of plywood, and rolling the piece of plywood into a substantially cylindrical shape.

One embodiment of a drum shell according to the present disclosure includes a piece of plywood in a generally cylindrical shape, the piece of plywood including at least a first ply and a second ply. The ends of the first ply form a first joint and the ends of the second ply form a second joint, with both the first and second plies in a generally cylindrical shape. The first and second joints are separated from each other, such as being separated by 5° or more radially.

Another embodiment of a method of manufacturing according to the present disclosure includes scarfing a first piece of wood including one or more plies, and scarfing a second piece of wood also including one or more plies. After the first piece of wood is rolled into a generally cylindrical shape, the second piece of wood is rolled into a generally cylindrical shape and attached to the outside of the first piece of wood such that the scarf joint of the first piece of wood and the scarf joint of the second piece of wood are separated, such as separated by 5° or more.

The above summary has outlined, rather broadly, some features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same or similar purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE FIGURES

FIG. 1A is a schematic view of one end of a piece of plywood for use as a drum shell, prior to scarfing of the end of the piece of plywood;

FIG. 1B is a schematic view of the end of the piece of plywood from FIG. 1A, after prior art scarfing of the end of the piece of plywood;

FIG. 2A is a schematic view of a piece of plywood according to the present disclosure; and

FIG. 2B is a schematic view of a generally cylindrical drum shell according to the present disclosure.

### DETAILED DESCRIPTION OF THE DISCLOSURE

Disclosed herein are drum shells and methods of forming drum shells with plies that are individually scarfed, or with combinations of plies that are scarfed separately from one or more other plies. In some embodiments, the radial location of the joints of the plies can be varied around the drum shell, resulting in the removal of an inherent weak point in traditionally formed drum shells where all plies have a joint at approximately the same radial position.

It is understood that when an element is referred to as being “on” another element, it can be directly on the other element or intervening elements may also be present. Further, when one element is referred to as being “connected” to another element, it can be directly connected to the other element or intervening elements may also be present as would be understood by one of skill in the art. Furthermore, relative terms such as “inner”, “outer”, “upper”, “top”, “above”, “lower”, “bottom”, “beneath”, “below”, and similar terms, may be used herein to describe a relationship of one element to another. Terms such as “higher”, “lower”, “wider”, “narrower”, and similar terms, may be used herein to describe angular and/or relative relationships. It is understood that these terms are intended to encompass different orientations of the elements or system in addition to the orientation depicted in the figures.

Although the terms first, second, etc., may be used herein to describe various elements, components, regions and/or sections, these elements, components, regions, and/or sections should not be limited by these terms. These terms are only used to distinguish one element, component, region, or section from another. Thus, unless expressly stated otherwise, a first element, component, region, or section discussed below could be termed a second element, component, region, or section without departing from the teachings of the present disclosure.

Embodiments of the disclosure are described herein with reference to view illustrations that are schematic illustrations. As such, the actual thickness of elements can be different, and variations from the shapes of the illustrations as a result, for example, of manufacturing techniques and/or tolerances are expected. Thus, the elements illustrated in the figures are schematic in nature and their shapes are not intended to illustrate the precise shape of a region and are not intended to limit the scope of the disclosure.

In one embodiment of a method according to the present disclosure, the ends of individual plies of wood are scarfed prior to being attached to one another to form plywood (using, e.g., an adhesive such as glue, epoxy, or in another manner), and prior to being rolled into a generally cylindrical shape for use as a drum shell. In other “reduced-ply scarfing” embodiments, a combination of plies that includes less than all of the plies of the desired drum shell is scarfed separately from the remaining ply or plies. For example, a first two-ply plywood could be scarfed separately from a second two-ply plywood, the four plies (and two plywoods) eventually being combined to form the desired drum shell. It is understood that while the below description often refers to scarfing of individual plies, these same concepts could be applied and/or adapted to reduced-ply scarfing. Further, while the below description refers to the scarfing of individual plies, that is not to say that the individual plies (or reduced plies) cannot be scarfed at the same time, but instead refers to the fact that the individual plies (or reduced plies) have not yet been attached to one another. For example, two plies of wood could be placed on top of one another and/or held stationary against one another and scarfed at the same time using the same blade and/or machine, and later attached to one another such that their respective scarf joints (i.e., the points where ends of plies of wood, after being rolled, meet one another to form a joint, often being joined by an adhesive such as glue or epoxy) are at different radial points once the plywood is rolled into a drum shell.

The scarfing of individual plies can provide for greater customization and user choice over the prior art, as well as new scarf joint arrangements. For example, the scarf joints can be staggered or placed at different points radially around the circumference of the drum shell. In one embodiment of the present disclosure, two or more scarf joints from different plies are separated or offset (the term “separated” used hereafter for simplicity) from one another by 5° or more; in another embodiment, 10° or more; in another embodiment, 15° or more; in another embodiment, 22.5° or more; in another embodiment, 45° or more; in another embodiment, 60° or more; in another embodiment, 75° or more; in another embodiment, 90° or more; in another embodiment, 120° or more; in another embodiment, 135° or more; in another embodiment, 150° or more; in another embodiment, 165° or more; and in another embodiment, approximately 180°. For example, FIG. 2B, to be discussed in more detail below, shows one embodiment of a cylindrical drum shell 200′ including two plies or ply combinations 202′,204′, the first ply 202′ having a scarf joint 203 and the second ply 204′ having a scarf joint 205, the scarf joints 203,205 separated by 5° or more (in this specific embodiment, approximately 45°).

In one specific embodiment, alternating plies have joints that are separated from one another by approximately 90° or more, or by approximately 120° or more, or by approximately 180°. In one specific embodiment, two or more inner plies and/or all inner plies have joints approximately at the same radial angle, while the outermost ply has a joint that is separated from the other joints by any of the previously discussed angles. Many different embodiments are possible.

Separation of scarf joints can result in the elimination of a weak point of a traditionally scarfed drum shell: the radial point where all plies have a joint; and/or can result in the weakest point radially about the drum being stronger than the weakest point of a traditionally scarfed drum shell. Scarfing of individual plies can have additional distinct advantages over the prior art. For example, it can result in a more pure sound from the final drum shell, and/or can aid in better controlling the final diameter of the drum shell. Additionally, it can lessen the manufacturing rejection rate, since an improperly scarfed joint would result in the loss of a single ply instead of all of the plies of the potential drum shell. Additionally, it can result in fewer ply fractures or other unintended alterations which the wood may experience during multi-ply scarfing.

Embodiments of the present disclosure can include any number of plies (or combinations of plies) and any number of scarf joints, including but not limited to two plies (or ply combinations), three plies, four plies, five plies, eight plies, ten plies, or more, and/or including two scarf joints, three scarf joints, four scarf joints, five scarf joints, eight scarf joints, ten scarf joints, or more.

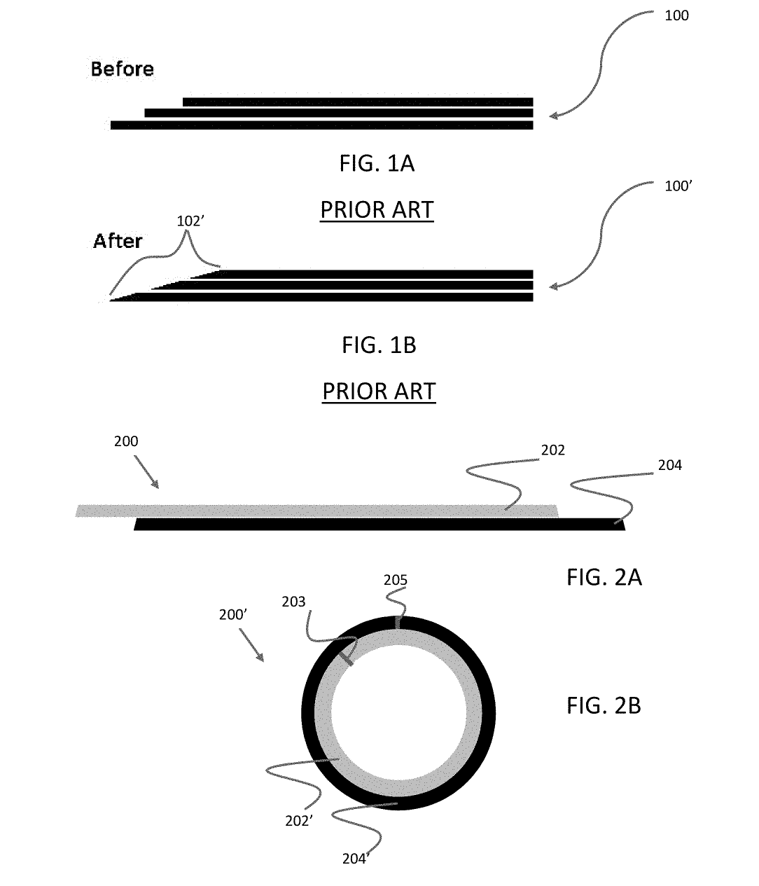

Additionally, in another embodiment, different types of scarf joints can be used for different plies. For example, the outermost ply can include a more secure scarf joint which may be more difficult and/or expensive to make, such as a scarf joint including male/female, protrusion/recession, and/or tab/slot style connections. In addition, mechanical fasteners such as screws, nails, bars, mesh, metal reinforcement, and other mechanical fasteners as would be understood by one of skill in the art could also be used at the outermost scarf joint to increase its strength. Inclusion of a more secure joint in the outermost ply can be more important to the structural integrity of the drum shell than with inner plies, and as such in some embodiments the inner plies may not include such elements, but could, for example, be a simple angled scarf joint such that the two ends of each of the plies become flush with one another (for example, FIG. 1B shows a piece of plywood that has a simple angled scarf on its end 102′). It is understood that while this paragraph discusses different types of scarf joints and/or mechanical fasteners for use with the outermost apply, these same concepts can be applied to inner plies in addition to or in place of the outermost ply.

Plies of wood (and/or multi-ply combinations) can be scarfed together while still not being permanently attached to one another. For instance, one ply can be placed on top of one another such that the ends of the two plies line up with one another, and then the ends of the plies scarfed at the same time. The plies (and/or multi-ply combinations) can then be attached to one another as will be described below with regard to FIGS. 2A and 2B, or via another method.

After scarfing, the scarfed plies can be connected to one another while still flat (e.g., using an adhesive such as glue or epoxy), prior to rolling. For example, as shown in FIG. 2A, the two plies 202,204 of the plywood 200 are attached so as to be offset from one another such that their ends are misaligned. The plywood 200 can then be rolled and the ends of each ply attached to one another, such as by using an adhesive such as glue or epoxy, to form scarf joints 203,205 and to form the cylindrical drum shell 200′. As shown in FIG. 2B, this process results in the scarf joint 203 of the inner ply 202′ being separated from the scarf joint 205 of the outermost ply 204′, such as by the previously discussed angles (e.g., 5° or more). In the specific embodiment shown the scarf joints 203,205 are separated from one another by approximately 45°. It is understood that the method and devices described with respect to FIGS. 2A and 2B can also be applied to reduced-ply methods and devices other than single-ply methods and devices, and more than two plies or combinations of plies can be combined using this method to form a drum shell.

In another embodiment a first ply (or combination of plies) can be rolled and its ends attached to one another, and then each successive ply (or combination of plies) rolled therearound. Joint formation can occur after each successive ply or combination of plies is rolled. In some embodiments, each successive ply is attached as it is rolled around the previous ply.

It is understood that various attributes and elements of from any one embodiment can also be included in other embodiments. Although the present disclosure has been described in detail with reference to certain preferred configurations thereof, other versions are possible. The actual scope of the disclosure encompasses not only the disclosed embodiments, but also all equivalent ways of practicing or implementing the disclosure. The above detailed description of the embodiments of the disclosure is not intended to be exhaustive or to limit the disclosure to the precise form disclosed above or to the particular field of usage mentioned in this disclosure. While specific embodiments of, and examples for, the disclosure are described above for illustrative purposes, various equivalent modifications are possible within the scope of the disclosure, as those skilled in the relevant art will recognize. The elements and acts of the various embodiments described above may be combined to provide further embodiments. Further, the teachings of the disclosure provided herein may be applied to products and systems other than percussion instruments, including but not limited to other musical instruments.

We claim:

1. A method of manufacturing a drum shell, comprising:
scarfing a first ply of wood;
scarfing a second ply of wood separate from said first ply of wood;
combining said first and second plies of wood into a piece of plywood; and
rolling said piece of plywood into a substantially cylindrical shape.

2. The method of claim 1, wherein said first ply of wood comprises a first end and a second end, and said second ply of wood comprises a third end and a fourth end;
wherein said rolling comprises rolling such that said first and second ends combine to form a first joint, and such that said third and fourth ends combine to form a second joint; and
wherein said first joint and said second joint are separated by 5° or more.

3. The method of claim 2, wherein said first joint and said second joint are separated by 45° or more.

4. The method of claim 2, wherein said first joint and said second joint are separated by 90° or more.

5. The method of claim 1, wherein said first and second ends are combined to form said first joint with a first adhesive, and wherein said third and fourth ends are combined to form said second joint with a second adhesive the same as or different than said first adhesive.

6. The method of claim 5, wherein said first and second adhesives are glue or epoxy.

7. The method of claim 1, further comprising scarfing a third ply of wood separate from said first ply of wood and said second ply of wood, and wherein said combining comprises combining said first, second, and third plies of wood into a piece of plywood prior to said rolling.

8. The method of claim 1, wherein said first ply of wood is combined with a third ply of wood prior to said scarfing said first ply of wood; wherein said scarfing of said first ply of wood comprises scarfing the combination of said first and third plies of wood; and
wherein said combining said first and second plies of wood into said piece of plywood comprises combining said second ply of wood with the combination of said first and third plies of wood to form said piece of plywood.

9. A drum shell, comprising:
a piece of plywood in a generally cylindrical shape, said piece of plywood comprising at least a first ply of wood and a second ply of wood;
wherein said first ply comprises a first ply first end and a first ply second end, said first ply first end and said first ply second end meeting to form a first ply joint such that said first ply is in a generally cylindrical shape; and
wherein said second ply comprises a second ply first end and a second ply second end, said second ply first end and said second ply second end meeting to form a second ply joint such that said second ply is in a generally cylindrical shape; and
wherein said first ply joint and said second ply joint are separated from each other.

10. The drum shell of claim 9, wherein said first ply joint and said second ply joint are separated by 5° or more.

11. The drum shell of claim 9, wherein said first ply joint and said second ply joint are separated by 45° or more.

12. The drum shell of claim 9, wherein said first ply joint and said second ply joint are separated by 90° or more.

13. The drum shell of claim 9, wherein said first ply joint comprises a male-female connection.

14. The drum shell of claim 9, wherein each of said first ply joint and said second ply joint is a scarf joint.

15. The drum shell of claim 9, wherein said first ply and said second ply are glued to each other.

16. The drum shell of claim 9, said piece of plywood further comprising at least a third ply of wood;
wherein said third ply comprises a third ply first end and a third ply second end, said third ply first end and said third ply second end meeting to form a third ply joint such that said third ply is in a generally cylindrical shape; and
wherein said third ply joint is separated from each of said first ply joint and said second ply joint by 5° or more.

17. The drum shell of claim 16, wherein said first ply joint, said second ply joint, and said third ply joint are each separated from one another by 45° or more.

18. A method of manufacturing a drum shell, comprising:
scarfing a first piece of wood comprising one or more plies, resulting in first and second scarfed ends;
rolling said first piece of wood to form a generally cylindrical shape, the first and second scarfed ends combining to form a first joint;
scarfing a second piece of wood comprising one or more plies, resulting in third and fourth scarfed ends;
rolling said second piece of wood to form a generally cylindrical shape, the third and fourth scarfed ends combining to form a second joint; and
attaching said rolled second piece of wood to an outside of said rolled first piece of wood such that said first joint and said second joint are separated by 5° or more.

19. The method of claim 18, wherein said attaching comprises attaching such that said first joint and said second joint are separated by 45° or more.

20. The method of claim 18, wherein said attaching and said rolling said second piece of wood are performed substantially simultaneously.

21. The method of claim 18, further comprising:
scarfing a third piece of wood comprising one or more plies, said scarfing resulting in fifth and sixth scarfed ends;
rolling said third piece of wood to form a generally cylindrical shape, the fifth and sixth scarfed ends combining to form a third joint; and
attaching said rolled third piece of wood to an outside of said second rolled piece of wood such that said first joint, said second joint, and said third joint are separated from each other by 5° or more.
